(19) United States
(12) Patent Application Publication
(10) Pub. No.: US 2026/0205195 A1
(43) Pub. Date: Jul. 16, 2026

(54) DECODING METHOD, ENCODING METHOD, DECODING SYSTEM, AND ENCODING SYSTEM

(71) Applicant: CASIO COMPUTER CO., LTD., Tokyo (JP)

(72) Inventor: Naotomo MIYAMOTO, Tokyo (JP)

(73) Assignee: CASIO COMPUTER CO., LTD., Tokyo (JP)

(21) Appl. No.: 19/413,183

(22) Filed: Dec. 9, 2025

(30) Foreign Application Priority Data
Jan. 15, 2025 (JP) 2025-005396

(51) Int. Cl. H04B 10/116

(52) U.S. Cl. CPC H04B 10/116

(57) ABSTRACT

The decoding method detects a change pattern Pm indicating a temporal change in color of the visible light, based on event data e output from a receiver (step S15), detects a frequency fn at which a change in a state of the visible light occurs, based on the change pattern (step S16), and decodes transmission data D corresponding to a temporal change in the color of the visible light emitted from a transmitter by combining a first numerical value D1 obtained from the change pattern Pm and a second numerical value D2 obtained from the frequency fn (steps S18 and S19).

### CROSS-REFERENCE TO RELATED APPLICATIONS

This application claims the benefit of Japanese Patent Application No. 2025-005396, filed on January 15, 2025, the entire disclosure of which is incorporated by reference herein.

### FIELD OF THE INVENTION

This application relates to a decoding method, an encoding method, a decoding system, and an encoding system.

### BACKGROUND OF THE INVENTION

Patent Literature 1 (Unexamined Japanese Patent Application Publication No. 2022-097664) discloses a visible light communication system. The visible light communication system encodes transmission data on the transmission side by changing a flashing interval of flashing light within a scanning time equivalent to one frame of an image sensor on the reception side. In the image sensor on the reception side, a bright and dark line pattern with width corresponding to the flashing interval of the flashing light is imaged, and the transmission data is decoded based on the bright and dark line pattern.

The present disclosure has been made in consideration of the above-described circumstances, and an objective of the present disclosure is to provide a decoding method, an encoding method, a decoding system, and an encoding system capable of increasing the amount of data transmittable and receivable within a limited time in the visible light communication.

### SUMMARY OF THE INVENTION

In order to achieve the above-described objective, a decoding method according to the present disclosure causes a computer that processes event data that are event data output from a receiver that receives the visible light emitted from a transmitter and including a position at which a change in brightness has occurred within a light receiving surface of the receiver, a time at which the change in brightness has occurred, and a polarity of the change, to: detect a change pattern that indicates a temporal change in a state of the visible light, based on the event data that are output from the receiver; detect a frequency at which the change in the state of the visible light occurs, based on the change pattern; and decode transmission data corresponding to the temporal change in the state of the visible light emitted from the transmitter by combining a first numerical value obtained from the change pattern and a second numerical value obtained from the frequency.

### BRIEF DESCRIPTION OF DRAWINGS

A more complete understanding of this application can be obtained when the following detailed description is considered in conjunction with the following drawings, in which:

FIG. 1A is a block diagram illustrating a configuration of an optical communication system according to Embodiment 1;

FIG. 1B is a diagram illustrating an example of an array of filter elements in a color filter;

FIG. 2 is a diagram illustrating an example of processing of an encoder;

FIG. 3 is a diagram illustrating an example of processing of a decoder;

FIG. 4 is a flowchart of encoding processing;

FIG. 5 is a flowchart of decoding processing;

FIG. 6 is a block diagram illustrating a configuration of an optical communication system according to Embodiment 2;

FIG. 7 is a diagram illustrating an example of processing of an encoder;

FIG. 8 is a diagram illustrating an example of processing of a decoder;

FIG. 9 is a flowchart of decoding processing;

FIG. 10A is a diagram illustrating a first variation of a signal pattern;

FIG. 10B is a diagram illustrating a second variation of the signal pattern; and

FIG. 10C is a diagram illustrating a third variation of the signal pattern.

### DETAILED DESCRIPTION OF THE INVENTION

A program and the like according to embodiments are described below with reference to the drawings. Note that the same or equivalent constituent components are designated by the same reference numerals in the drawings

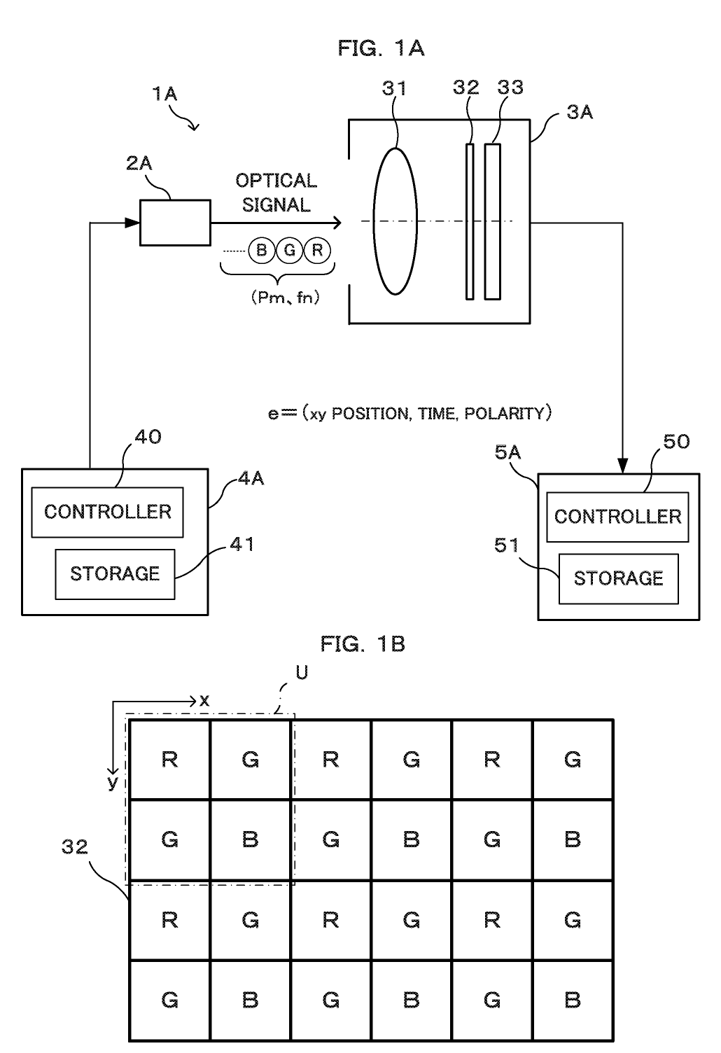

Next, Embodiment 1 of the present disclosure is described. As illustrated in FIG. 1A, an optical communication system 1A according to the present embodiment performs information communication through an optical communication method using the visible light. The optical communication system 1A performs communication, based on a temporal change in color of the visible light among states of the visible light. The optical communication system 1A includes a transmitter 2A, a receiver 3A, an encoder 4A, and a decoder 5A.

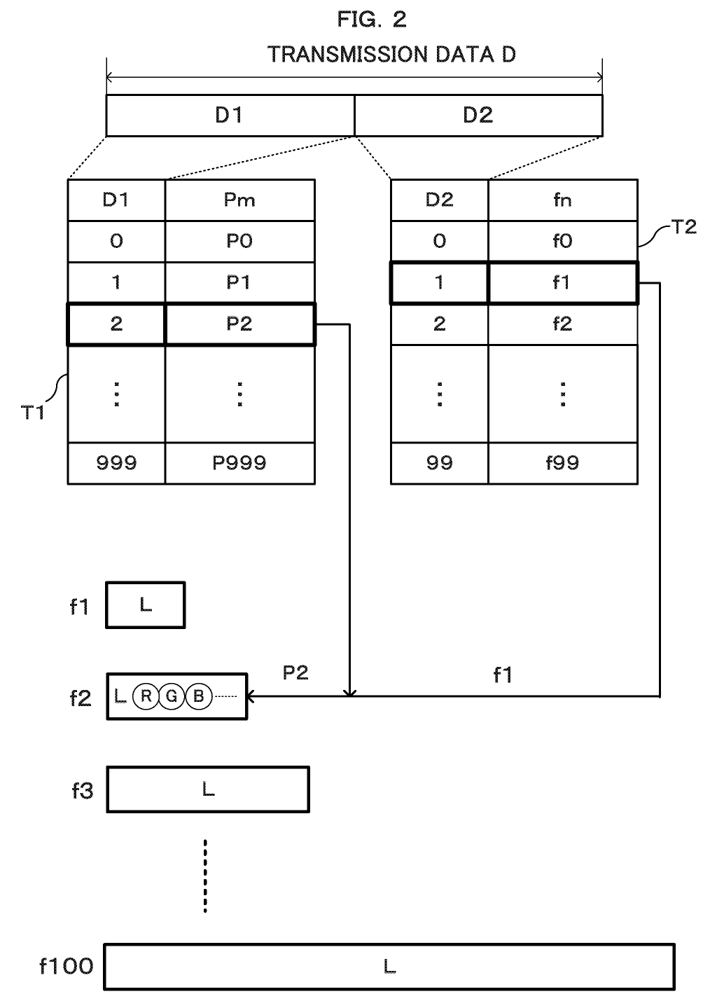

The transmitter 2A is a light-emitting diode (LED) light source capable of emitting light in three colors, namely red (R), green (G), and blue (B). The transmitter 2A emits light in one of R, G, and B with a predetermined brightness value (for example, 255 in 8-bit gradation). The transmitter 2A is capable of switching the color of light to be emitted at an arbitrary frequency fn. The transmitter 2A is capable of emitting light in a change pattern Pm that indicates the temporal change in color corresponding to transmission data D (see FIG. 2), by switching emission color at the frequency fn. Because of this configuration, an optical signal the emission color of which switches at the frequency fn in accordance with the change pattern Pm is transmitted from the transmitter 2A at the frequency fn. The frequency fn is adjustable. For example, the transmitter 2A is capable of switching emission color at 100 Hz or switching emission color at 1 Hz. Note that the frequency fn may be a frequency including digits after the decimal point, such as 1.1 Hz. Note that as long as the transmitter 2A is capable of emitting light in the three colors R, G, and B, a type of lighting tool or principle of light emission of the transmitter 2A is not specifically limited.

As illustrated in FIG. 1A, the receiver 3A receives the visible light emitted from the transmitter 2A. The receiver 3A is an event camera that detects a change in brightness of received light as an event and that outputs event data e related to the event. The event data e include data indicating a two-dimensional position (xy position) within a light receiving surface at which a change has occurred, a time (time stamp) at which the change has occurred, and a polarity of the change in brightness.

The receiver 3A includes an optical system 31, a color filter 32, and an image sensor 33. The optical system 31 causes light that is incident from the outside, such as an optical signal emitted from the transmitter 2A, to be refracted and incident on the color filter 32. The color filter 32 includes, as illustrated in FIG. 1B, filter elements corresponding to RGB color components arranged in a two-dimensional array in an xy plane. A filter element transmits light with a wavelength of a corresponding one of the RGB color components, on an element-by-element basis. That is, the color filter 32 is a filter in which a plurality of filter elements each of which transmits a different color component is arranged. The color filter 32 is, for example, an RGB filter having a Bayer array in which with respect to each group of filter elements arranged in a 2× 2 array, one R filter and one B filter are arranged diagonally and two G filters are arranged diagonally. Note that the arrangement of the color filter 32 is not limited to the Bayer array.

The image sensor 33 is a solid-state image sensor that detects a subject image produced through the optical system 31 and the color filter 32 and that subjects the detected subject image to photoelectric conversion. A plurality of imaging pixels (pixel sensors) that are arranged in a one-to-one correspondence with the filter elements of the color filter 32 are provided on the light receiving surface of the image sensor 33. Each imaging pixel detects light of one of the RGB components that is transmitted through a corresponding filter element, as a color change. Note that the receiver 3A may be a receiver that, without including the color filter 32, includes an image sensor in which imaging pixels each having sensitivity to one of R light, G light, and B light are arranged.

As illustrated in FIG. 1A, the encoder 4A is connected to the transmitter 2A. The encoder 4A is a computer that encodes transmission data D (see FIG. 2) to be transmitted by the transmitter 2A. That is, the encoder 4A encodes the transmission data D into the change pattern (signal pattern L) that indicates the temporal change in a state of the visible light to be emitted from the transmitter 2A. The encoder 4A includes a controller 40 and a storage 41.

The controller 40 includes a central processing unit (CPU), a read only memory (ROM), a random access memory (RAM), a real time clock (RTC), and the like. The CPU is also referred to as a central processing unit, a central operation device, a processor, a microprocessor, a microcomputer, a digital signal processor (DSP), or the like, and functions as a central operation processor (processor) that executes processing and calculation related to control of the encoder 4A. The CPU retrieves a program and data stored in the ROM and, using the RAM as a work area, controls the encoder 4A in a unified manner. The RTC is, for example, an integrated circuit having a timing function. Note that the CPU is capable of acquiring time information read out from the RTC. Further, the CPU included in the controller 40 may be configured as a single processor, a multiprocessor, a multi-core processor, or the like, or may be configured by combining any of these processors with processing circuity such as an application specific integrated circuit (ASIC) or a field-programmable gate array (FPGA).

As illustrated in FIG. 1A, the storage 41 includes a nonvolatile semiconductor memory, such as a flash memory, an erasable programmable ROM (EPROM), and an electrically erasable programmable ROM (EEPROM), and has a role as a so-called secondary storage device or auxiliary storage device. The storage 41 stores a program and data that the controller 40 uses to execute various types of processing. In addition, the storage 41 stores data that the controller 40 generates or acquires by executing the various types of processing. The encoder 4A achieves processing of encoding the transmission data D to be transmitted by the transmitter 2A, by the controller 40 executing the program stored in the storage 41. Note that examples of the transmission data D include identification information (ID).

As illustrated in FIG. 1A, the decoder 5A is connected to the receiver 3A. The decoder 5A is a computer that processes event data e output from the receiver 3A. The decoder 5A decodes transmission data D from an optical signal received by the receiver 3A, based on the event data e. The decoder 5A includes a controller 50 and a storage 51. A hardware configuration of the controller 50 is the same as the controller 40, and is a configuration as described above. A hardware configuration of the storage 51 is the same as the storage 41, and is a configuration as described above. The decoder 5A achieves processing of decoding an optical signal received by the receiver 3A, by the controller 50 executing a program stored in the storage 51. The decoder 5A also includes a man-machine interface that performs operation input and image display and a communication interface that performs data communication.

Encoding and decoding of transmission data D are described below. The controller 40 of the encoder 4A divides, as illustrated in FIG. 2, the transmission data D into a first numerical value D1 that is a value represented by a plurality of higher-order decimal digits and a second numerical value D2 that is a value represented by the remaining digits. When the number of digits of the second numerical value D2 is denoted by k, the transmission data D can be expressed as D1 × 10^k + D2.

As illustrated in FIG. 2, in the storage 41 of the encoder 4A, a table T1 that indicates a relationship between a first numerical value D1 and the change pattern Pm is stored. For example, when the number of digits of the first numerical value D1 is 3, the first numerical value D1 takes a value from 0 to 999. In the table T1, each of the values of the first numerical value D1 ranging from 0 to 999 is associated with one of the change patterns Pm (m = 0 to 999). In the present embodiment, the change pattern Pm is the change pattern of color in which emission colors R, G, B, and so on in the transmitter 2A temporally change, as illustrated in FIG. 1A, and P0 to P999 denote patterns different from one another. Note that when the three colors R, G, and B are changed 12 times, it is possible to generate approximately 1000 change patterns Pm.

Further, in the storage 41 of the encoder 4A, a table T2 that indicates a relationship between a second numerical value D2 and a frequency fn of a signal pattern L is stored. As illustrated in FIG. 2, when, for example, the number of decimal digits of the second numerical value D2 is 2, the second numerical value D2 takes a value from 0 to 99. In the table T2, each of the values of the second numerical value D2 ranging from 0 to 99 is associated with one of frequencies fn (n = 0 to 99) of the change pattern Pm. The frequencies fn (n = 0 to 99) of the change pattern Pm take values such as 1, 2, 3, . . . , and 100 Hz, and are frequencies different from one another.

The encoder 4A retrieves the change pattern Pm corresponding to the first numerical value D1 and also retrieves a frequency fn corresponding to the second numerical value D2, with reference to the tables T1 and T2 stored in the storage 41. For example, when the first numerical value D1 is 2, the change pattern P2 is retrieved, and when the second numerical value D2 is 1, a frequency f1 is retrieved. The encoder 4A generates a signal pattern L of the change pattern Pm in accordance with which color changes at the retrieved frequency fn. For example, when the change pattern P2 and the frequency f1 are retrieved, the encoder 4A generates a signal pattern L in which the color changes in accordance with the change pattern P2 at the frequency f1. The encoder 4A outputs the generated signal pattern L to the transmitter 2A. The transmitter 2A emits light in accordance with the signal pattern L. As a result, an optical signal of the signal pattern L is emitted from the transmitter 2A.

The receiver 3B outputs event data e every time the color of a signal pattern L of a received optical signal changes. The receiver 3B is a so-called event camera, and when a change in the brightness of each imaging pixel in the image sensor 33 exceeds a predetermined threshold value, the receiver 3B detects the change as an event. The threshold value is, although not specifically limited, for example, approximately 200 in the 8-bit gradation. The receiver 3B asynchronously outputs an xy position, a time (time stamp), and a (brightness) polarity of an imaging pixel where an event is detected, as event data e (x, y, t, ±) to the decoder 5A.

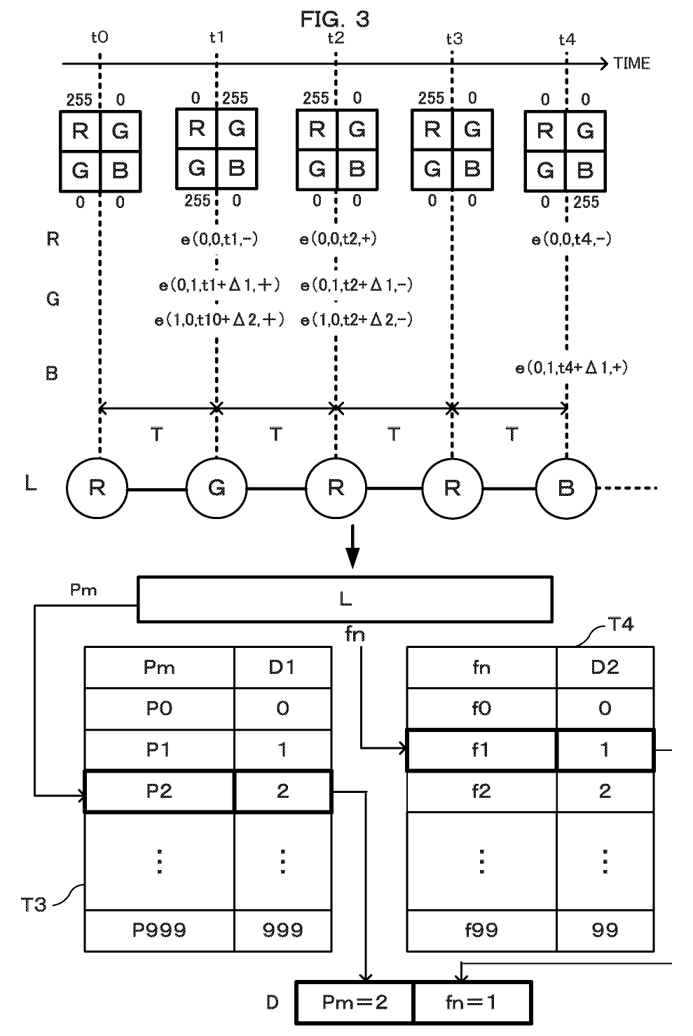

Herein, to simplify the description, the description is made with respect to only four pixels corresponding to a single color array unit U (within a dashed-two-dotted line in FIG. 1B). It is assumed that in a single color array unit U, the xy position of an imaging pixel corresponding to a filter element that transmits the R (red) light is (0, 0), the xy positions of imaging pixels corresponding to filter elements that transmit the G (green) light are (0, 1) and (1, 0), and the xy position of an imaging pixel corresponding to a filter element that transmits the B (blue) light is (1, 1). In the example illustrated in FIG. 3, at time t1, event data e (0, 0, t1, -) are output. The first (0, 0) indicates the xy position of an imaging pixel, t1 indicates a time (time stamp) at the moment, and "-" indicates that a brightness value changed from 255 to 0. Therefore, the event data e indicates that at time t1, the brightness value of the red light has decreased from 255 to 0.

Likewise, the receiver 3A outputs event data e (0, 1, t1 + Δ1, +) and e (1, 0, t1 + Δ2, +). The event data e indicate that at times t1 + Δ1 and t1 + Δ2, the brightness values of the green light have increased from 0 to 255. Δ1 and Δ2 indicate minute lags in timings at which individual event data e are output, and Δ1 and Δ2 can be approximated to zero. That is, the above-described event data e can be considered to indicate that the color of the received optical signal has changed from red to green at time t1. The following description is made with Δ1 and Δ2 considered to be practically zero.

Likewise, at time t2, the receiver 3A outputs event data e (0, 0, t2, +), event data e (0, 1, t2 + Δ1, -), and event data e (1, 0, t2 + Δ2, -). The above-described event data e indicate that the color of the received optical signal has changed from green to red.

At time point t3, the receiver 3A does not output event data e. This situation indicates that the color of the received optical signal remains red and does not change at time t3.

At time t4, the receiver 3A outputs event data e (0, 0, t4, -) and event data e (0, 1, t4 + Δ1, +). The above-described event data e indicate that the color of the received optical signal has changed from red to blue.

The above-described event data e are input to the decoder 5A. The decoder 5A detects a signal pattern L of the optical signal that is the change pattern indicating the temporal change in the state (color) of the visible light, based on the event data e that are output from the receiver 3A and input to the decoder 5A. The storage 51 of the decoder 5A includes an event buffer (not illustrated) to store event data e. The decoder 5A determines whether input event data e came from a signal pattern L of an optical signal or came from light from another light source and buffers the event data e that came from the signal pattern L of the optical signal in the event buffer.

The decoder 5A detects the signal pattern L of the optical signal, based on the event data e stored in the event buffer. In FIG. 3, an example in which a signal pattern L that at time t1, changes from R (red) to G (green), at time t2, changes from G (green) to R (red), at time t3, remains R (red), and at time t4, changes from R (red) to B (blue) is obtained is illustrated.

The controller 50 of the decoder 5A detects the change pattern Pm of the color, based on the obtained signal pattern L. Further, the controller 50 detects a frequency fn at which the state, that is, the color, of the visible light occurs, based on the obtained signal pattern L.

As illustrated in FIG. 3, in the storage 51 of the decoder 5A, a table T3 that indicates a relationship between the change pattern Pm and a first numerical value D1 is stored. Further, in the storage 51, a table T4 that indicates a relationship between a frequency fn of a signal pattern L and a second numerical value D2 is stored. The controller 50 detects, with reference to the above-described tables T3 and T4, a first numerical value D1 corresponding to the change pattern Pm and a second numerical value D2 corresponding to the frequency fn. For example, when the change pattern corresponding to the signal pattern L is P2, a value of 2 is read as the first numerical value D1 with reference to table T3, and when the frequency fn of the signal pattern L is f1, a value of 1 is read as the second numerical value D2 with reference to table T4.

Further, the controller 50 combines the first numerical value D1 obtained from the change pattern Pm and the second numerical value D2 obtained from the frequency fn and thereby decodes transmission data D corresponding to the temporal change in the state (color) of the visible light emitted from the transmitter 2A. For example, the controller 50 decodes a numerical value that includes a value represented by a predetermined number of higher-order decimal digits as the first numerical value D1 (2) and a value represented by the remaining lower-order decimal digits as the second numerical value D2 (1), as the transmission data D. The number of digits of the first numerical value D1 and the number of digits of the second numerical value D2 are set in advance. When k denotes the number of digits of the second numerical value D2, D1 × 10^k + D2 is calculated as the transmission data D. That is, the controller 50 decodes the transmission data D corresponding to the temporal change in the state of the visible light emitted from the transmitter 2A by combining the first numerical value D1 obtained from the change pattern Pm and the second numerical value D2 obtained from the frequency fn.

Next, operation of the optical communication system 1A according to the present embodiment is described. First, encoding processing (encoding method) executed in the encoder 4A is described, and next, decoding processing (decoding method) executed in the decoder 5A is described.

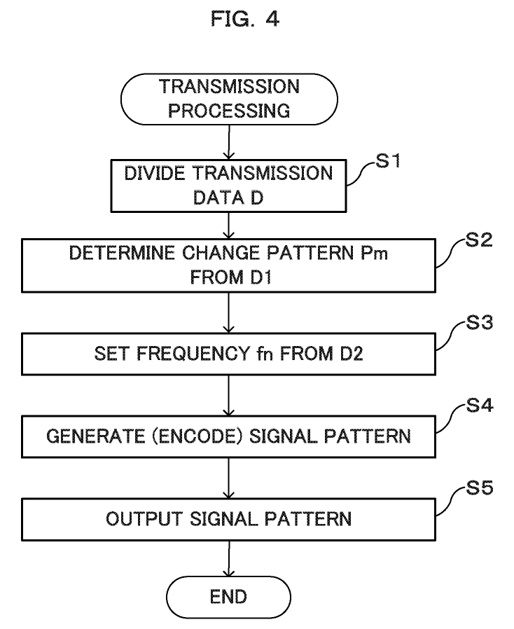

As illustrated in FIG. 4, in the encoding processing, first, the controller 40 of the encoder 4A acquires transmission data D and divides the transmission data D into a first numerical value D1 that is a value represented by a predetermined number of higher-order decimal digits and a second numerical value D2 that is a value represented by the remaining lower-order decimal digits (step S1). Next, the controller 40 determines the change pattern Pm corresponding to the first numerical value D1 with reference to the table T1 stored in the storage 41 (see FIG. 2) (step S2). Next, the controller 40 sets a frequency fn corresponding to the second numerical value D2 with reference to the table T2 stored in the storage 41 (see FIG. 2) (step S3). Next, the controller 40 generates a signal pattern L in which the emission color changes at the frequency fn in accordance with the change pattern Pm and thereby encodes the transmission data D (step S4). Next, the controller 40 outputs the signal pattern L to the transmitter 2A (step S5). As a result, an optical signal changing in accordance with the signal pattern L is transmitted from the transmitter 2A.

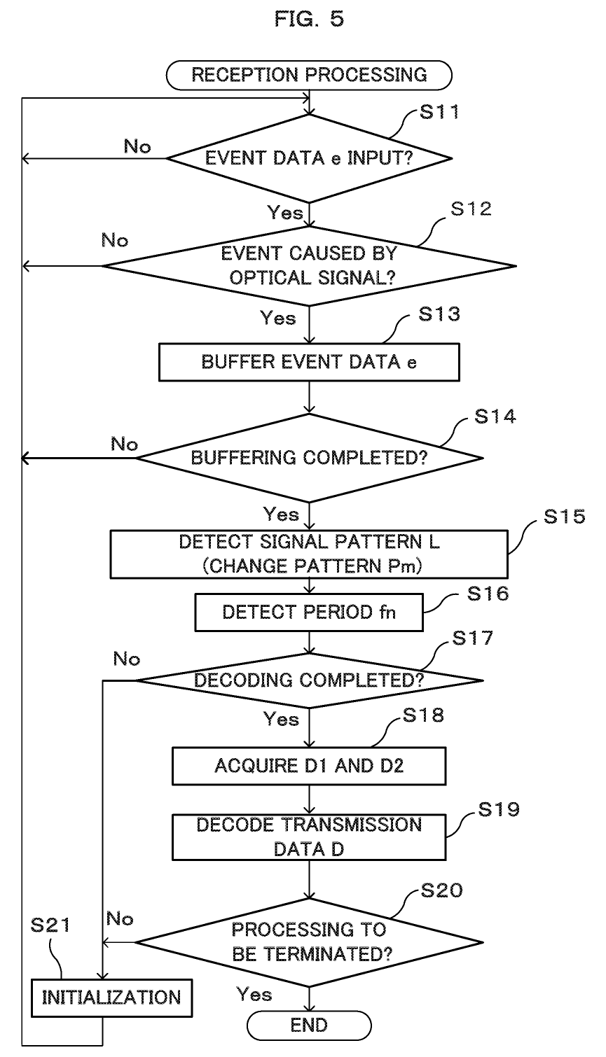

Next, the decoding processing executed by the decoder 5A is described. As illustrated in FIG. 5, first, the controller 50 of the decoder 5A waits until event data e are input from the receiver 3A (step S11; No). When event data e are input (step S11; Yes), the controller 50 determines whether or not the event data e represent an event occurring caused by an optical signal changing in accordance with a signal pattern L (step S12). The determination is performed based on, for example, whether or not the brightness value of a certain color changes in the negative direction while the brightness value of another color changes in the positive direction at the same timing. This is because performing the determination in this way enables the event data e to be considered as an event occurring caused by an optical signal. For example, when, as illustrated in FIG. 3, at time t1, the brightness value of the R (red) light changes in the negative direction and the brightness value of the G (green) light changes in the positive direction, the event data e can be considered as an event occurring caused by an optical signal.

When it is not determined that the event data e represent an event occurring caused by an optical signal (step S12; No), the controller 50 waits again for input of event data e (step S11; No). In contrast, when it is determined that the event data e represent an event occurring caused by an optical signal (step S12; Yes), the controller 50 buffers the event data in the event buffer (step S13). Next, the controller 50 determines whether or not the controller 50 has buffered a required number of pieces of event data e to decode the transmission data D and the buffering is completed (step S14). When, as illustrated in FIG. 3, a required number of pieces of event data e have not been buffered (step S14; No), the controller 50 waits again for input of event data e (step S11; No).

In this way, the controller 50 repeatedly executes steps S11 to S14 and buffers event data e representing an event occurring caused by an optical signal in the event buffer. When, as illustrated in FIG. 3, the required number of pieces of event data e are buffered (step S14; Yes), the controller 50 detects a signal pattern L, based on the buffered event data e (step S15). That is, in this step, a signal pattern L is detected by detecting the temporal change in the color of the visible light as the temporal change in the state of the visible light. The change pattern of the color in the signal pattern L serves as the change pattern Pm. Further, the controller 50 detects a frequency fn of the color change, based on the detected signal pattern L (step S16).

Next, the controller 50 determines whether or not the detected the change pattern Pm matches the change pattern of the transmission data D, the frequency fn falls within a preset frequency range, and the decoding has been completed normally (step S17). When there is an abnormality in the decoding result, the controller 50 determines that the decoding has not been completed (step S17; No), initializes the event buffer (step S21), and waits again for input of event data e (step S11; No).

When the decoding result is normal and the decoding is completed (step S17; Yes), the controller 50 acquires, with reference to the tables T3 and T4 stored in the storage 51, a first numerical value D1 corresponding to the change pattern Pm and a second numerical value D2 corresponding to the frequency fn (step S18). Next, the controller 50 combines the first numerical value D1 and the second numerical value D2 and thereby generates the transmission data D (step S19). A combination method is determined in advance, and the combination is performed with the same number of digits and arrangement as those in the division into the first numerical value D1 and the second numerical value D2 at the time of encoding.

Next, the controller 50 determines whether or not to terminate the decoding processing (step S20). The determination is performed by an operation input to the decoder 5A. When the decoding processing is not terminated (step S20; No), the controller 50 initializes the event buffer (step S21) and waits again for input of event data e (step S11; No). When the decoding processing is to be terminated (step S20; Yes), the controller 50 terminates the decoding processing.

The optical communication system 1A according to the present embodiment includes the transmitter 2A capable of emitting the visible light of the three colors RGB. However, the emission colors may be other colors. The optical communication system 1A is only required to be an optical communication system capable of emitting the visible light of at least two colors. The decoder 5A is only required to be a decoder capable of detecting the change pattern by detecting the temporal change in the color of the visible light as the temporal change in the state of the visible light.

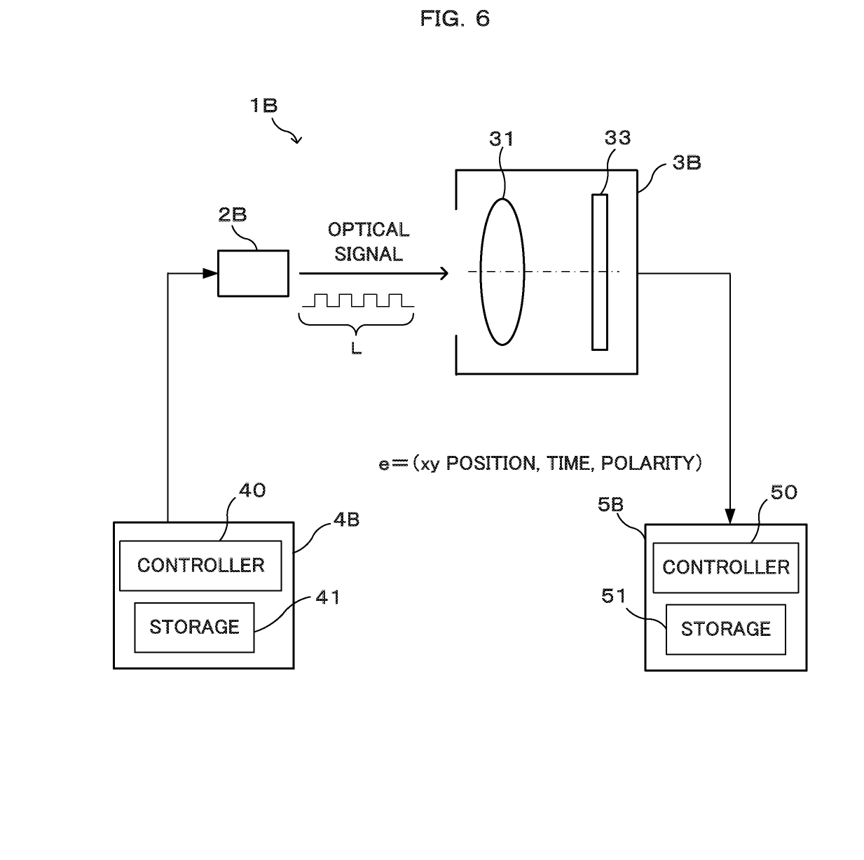

Next, Embodiment 2 of the present disclosure is described. As illustrated in FIG. 6, an optical communication system 1B according to the present embodiment is the same as the optical communication system 1A according to Embodiment 1 described above in that the optical communication system 1B performs optical communication making use of the visible light. The optical communication system 1B uses brightness of the visible light as the state of the visible light and performs communication, based on the temporal change in the state of the visible light. In this case, the change pattern of the brightness becomes a square wave. The optical communication system 1B includes a transmitter 2B, a receiver 3B, an encoder 4B, and a decoder 5B.

The transmitter 2B is different from the transmitter 2A in that the transmitter 2B is a light-emitting diode (LED) light source capable of emitting monochromatic light and emits monochromatic light with a predetermined brightness value (for example, 255 in 8-bit gradation).

As illustrated in FIG. 6, the receiver 3B is an event camera that detects a change in the brightness of received monochromatic light as an event and that outputs event data e related to the event.

As illustrated in FIG. 6, the encoder 4B is different from the encoder 4A in that the encoder 4B encodes transmission data D into a signal pattern L that is the change pattern indicating the temporal change in the brightness of monochromatic visible light to be emitted from the transmitter 2B.

As illustrated in FIG. 6, the decoder 5B decodes the transmission data D from an optical signal received by the receiver 3B, based on event data e indicating that the brightness of the received monochromatic light has changed.

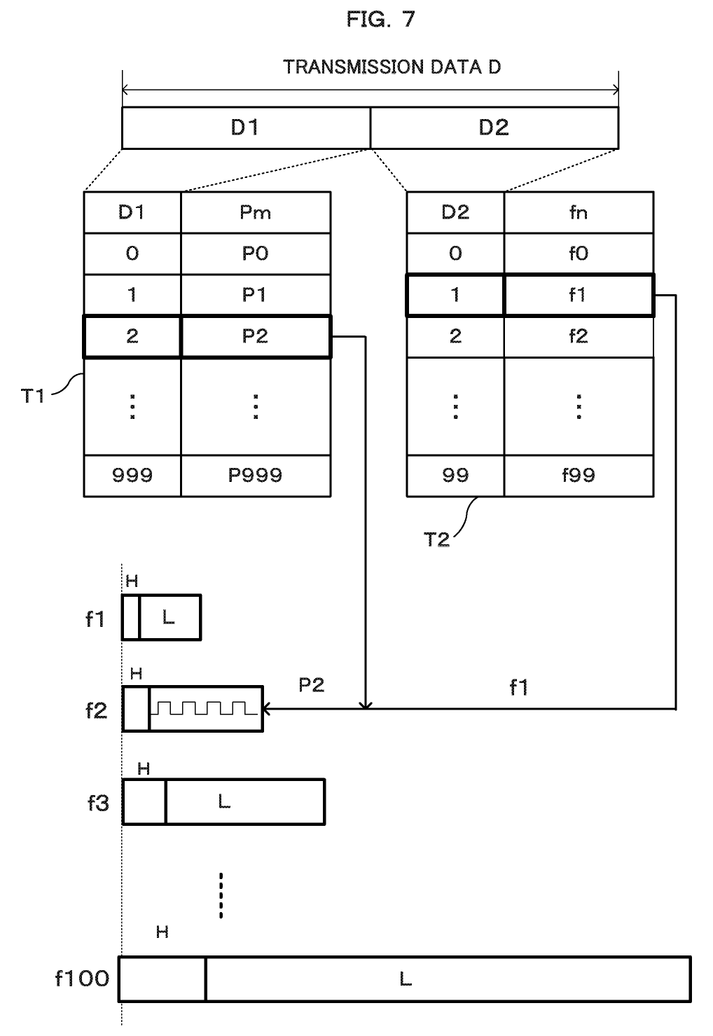

A controller 40 of the encoder 4B divides, as illustrated in FIG. 7, the transmission data D into a first numerical value D1 that is a value represented by a plurality of higher-order decimal digits and a second numerical value D2 that is a value represented by the remaining lower-order digits. When the number of digits of the second numerical value D2 is denoted by k, the transmission data D can be expressed as D1 × 10^k + D2.

As illustrated in FIG. 7, in a storage 41 of the encoder 4B, a table T1 that indicates a relationship between a first numerical value D1 and the change pattern Pm is stored. The change pattern Pm is, as illustrated in FIG. 7, the change pattern indicating the temporal change in intensity of light to be emitted from the transmitter 2B, and P0 to P999 denote the change patterns different from one another.

Further, in the storage 41 of the encoder 4B, a table T2 that indicates a relationship between a second numerical value D2 and a frequency fn of a signal pattern L is stored. The frequencies fn (n = 0 to 99) of the change pattern Pm take values such as 1, 2, 3, . . . , and 100 Hz, and are frequencies different from one another.

As illustrated in FIG. 7, the encoder 4B retrieves the change pattern Pm (for example, P2) corresponding to the first numerical value D1 (for example, 2) and also retrieves a frequency fn (for example, f1) corresponding to the second numerical value D2 (for example, 1), with reference to the tables T1 and T2 stored in the storage 41. The encoder 4B generates a signal pattern L of the change pattern Pm (for example, P2) in accordance with which brightness changes at the retrieved frequency fn (for example, f1). The encoder 4B outputs the generated signal pattern L to the transmitter 2B. The transmitter 2B emits light in accordance with the signal pattern L. As a result, an optical signal changing in accordance with the signal pattern L is emitted from the transmitter 2B.

The encoder 4B retrieves the change pattern Pm corresponding to the first numerical value D1 and also retrieves a frequency fn corresponding to the second numerical value D2, with reference to the tables T1 and T2 stored in the storage 41. The encoder 4B generates a signal pattern L of the change pattern Pm in accordance with which brightness changes at the retrieved frequency fn. The encoder 4B adds a header H to the head of the signal pattern L. The header H is a unique square wave pattern that indicates that the signal pattern L is an optical signal. The encoder 4B outputs the generated signal pattern L to the transmitter 2B. The transmitter 2B emits light in accordance with the signal pattern L. As a result, an optical signal changing in accordance with the signal pattern L is emitted from the transmitter 2B.

The receiver 3B outputs event data e every time the brightness changes in accordance with the signal pattern L of a received optical signal. The receiver 3B is a so-called event camera, and detects, when a change in the brightness of each imaging pixel in an image sensor 33 exceeds a predetermined threshold value, the change as an event. The threshold value is, although not specifically limited, for example, approximately 200 in the 8-bit gradation. The receiver 3B asynchronously outputs an xy position, a time (time stamp), and a (brightness) polarity of an imaging pixel where the event is detected, as event data e (x, y, t, ±) to the decoder 5B.

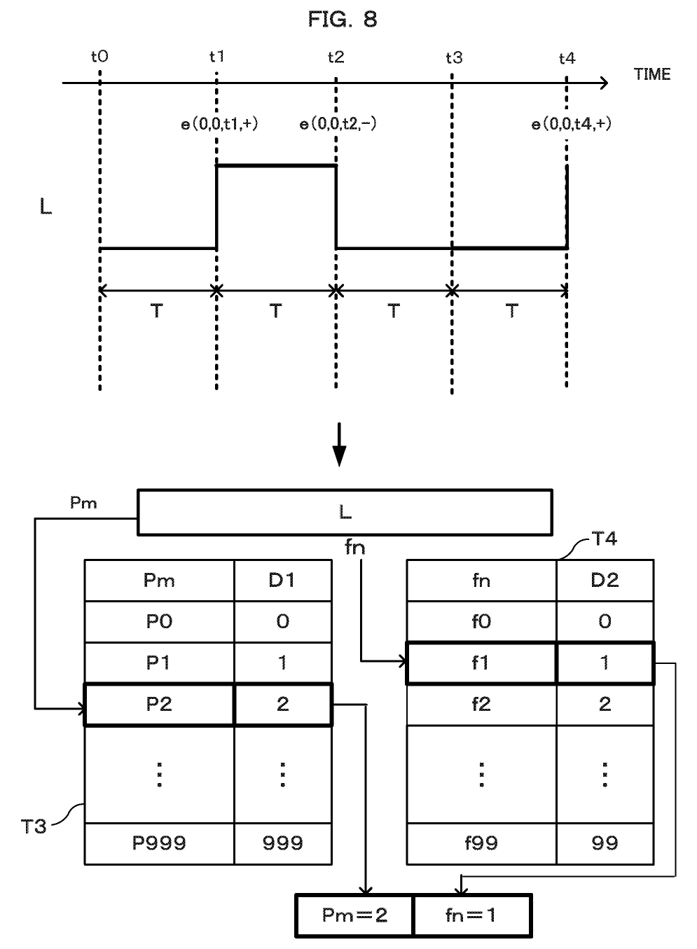

In the example illustrated in FIG. 8, at time t1, event data e (0, 0, t1, +) are output. The event data e indicate that at time t1, a brightness value detected by an imaging pixel located at (0, 0) has changed from 0 to 255. Further, at time t2, event data e (0, 0, t2, -) are output. The event data e indicate that at time t2, a brightness value detected by the imaging pixel located at (0, 0) has changed from 255 to 0. Further, at time t4, event data e(0, 0, t4, +) are output. The event data e indicate that at time t4, a brightness value detected by the imaging pixel located at (0, 0) has changed from 0 to 255.

The decoder 5B detects a signal pattern L of an optical signal that is the change pattern indicating the temporal change in the state (brightness) of the visible light, based on the event data e that are output from the receiver 3B and input to the decoder 5B. As illustrated in FIG. 8, the signal pattern L becomes a square wave pattern with a period T. Processing performed by the decoder 5B is the same as the processing performed by the decoder 5A in that the signal pattern L excluding the header H is stored in an event buffer of a storage 51, the change pattern Pm and a frequency fn of the signal pattern L are detected, a first numerical value D1 corresponding to the change pattern Pm and a second numerical value D2 corresponding to the frequency fn are identified with reference to tables T3 and T4, and the transmission data D is decoded based on a combination of the first numerical value D1 and the second numerical value D2.

Next, operation of the optical communication system 1B according to the present embodiment is described below. First, encoding processing executed in the encoder 4B is described, and next, decoding processing executed in the decoder 5B is described.

The encoding processing executed by the encoder 4B is the same as the encoding processing executed by the encoder 4A illustrated in FIG. 4. Note, however, that the encoding processing executed by the encoder 4B is different from the encoding processing executed by the encoder 4A illustrated in FIG. 4 only in that the signal pattern L generated by the encoder 4B is a pattern indicating the temporal change in the brightness of light.

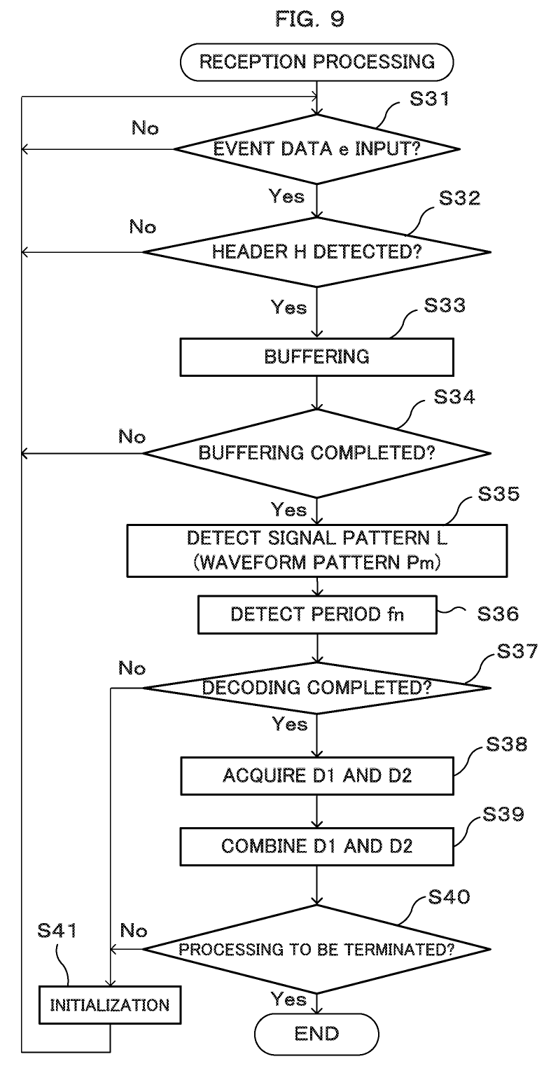

Next, the decoding processing executed by the decoder 5B is described. As illustrated in FIG. 9, first, a controller 50 of the decoder 5B waits until event data e are input from the receiver 3B (step S31; No). When event data e are input (step S31; Yes), the controller 50 determines whether or not a header H is detected (step S32). The determination is performed based on whether or not a pattern generated from the event data e that have been input until then match a pattern defined as the header H. This is because when the generated pattern matches the pattern defined as the header H, event data e that are to be succeedingly input in the same period can be considered to represent an event occurring caused by an optical signal. After the header H is detected, the determination in step S32 always results in Yes until step S35 is subsequently executed.

When no header H has been detected (step S32; No), the controller 50 waits again for input of event data e (step S31; No). In contrast, when a header H is detected (step S32; Yes), the controller 50 buffers the event data e in the event buffer (step S33). In this step, only event data e that occurs in the same period as a bit pattern constituting the header H are stored in the event buffer. Next, the controller 50 determines whether or not a required number of pieces of event data e to decode the transmission data D have been buffered and the buffering is completed (step S34). When a required number of pieces of event data e have not been buffered (step S34; No), the controller 50 waits again for input of event data e (step S31; No).

In this way, the controller 50 repeatedly executes steps S31 to S34 and buffers event data e representing an event occurring caused by an optical signal in the event buffer. When the required number of pieces of event data e are buffered (step S34; Yes), the controller 50 detects a signal pattern L, based on the buffered event data e (step S35). That is, in a first detection step, a signal pattern L is detected by detecting the temporal change in the brightness of the visible light as the temporal change in the state of the visible light. The change pattern of the brightness in the signal pattern L serves as the change pattern Pm. Further, the controller 50 detects a frequency fn of the brightness change, based on the detected signal pattern L (step S36).

Next, the controller 50 determines whether or not the detected the change pattern Pm matches the change pattern of the transmission data D, the frequency fn falls within a preset frequency range, and the decoding has been completed normally (step S37). When there is an abnormality in a decoding result, the controller 50 determines that the decoding has not been completed (step S37; No), initializes the event buffer (step S41), and waits again for input of event data e (step S31; No).

When the decoding result is normal and the decoding is completed (step S37; Yes), the controller 50 acquires a first numerical value D1 corresponding to the change pattern Pm and a second numerical value D2 corresponding to the frequency fn, with reference to the tables T3 and T4 stored in the storage 51 (step S38). Next, the controller 50 combines the first numerical value D1 and the second numerical value D2 and thereby generates the transmission data D (step S39). A combination method is determined in advance and is performed with the same number of digits and arrangement as those in the division into the first numerical value D1 and the second numerical value D2 at the time of encoding.

Next, the controller 50 determines whether or not to terminate the decoding processing (step S40). The determination is performed by an operation input to the decoder 5B. When the decoding processing is not terminated (step S40; No), the controller 50 initializes the event buffer (step S41) and waits again for input of event data e (step S31; No). When the decoding processing is to be terminated (step S40; Yes), the controller 50 terminates the decoding processing.

In a conventional visible light communication system, there is a limit to the amount of data that can be transmitted in one frame. In a case where the amount of data transmitted in one frame is to be increased, when flashing timing of flashing light and scanning timing of an image sensor become asynchronous, a possibility that transmission and reception of data fail increases. In contrast, as described in detail in the foregoing, according to the optical communication system 1A according to the present embodiment, since transmission data D can be encoded using not only the change pattern Pm of the signal pattern L but also the frequency fn of the signal pattern L, the amount of data that can be transmitted and received within a limited time in the visible light communication can be increased.

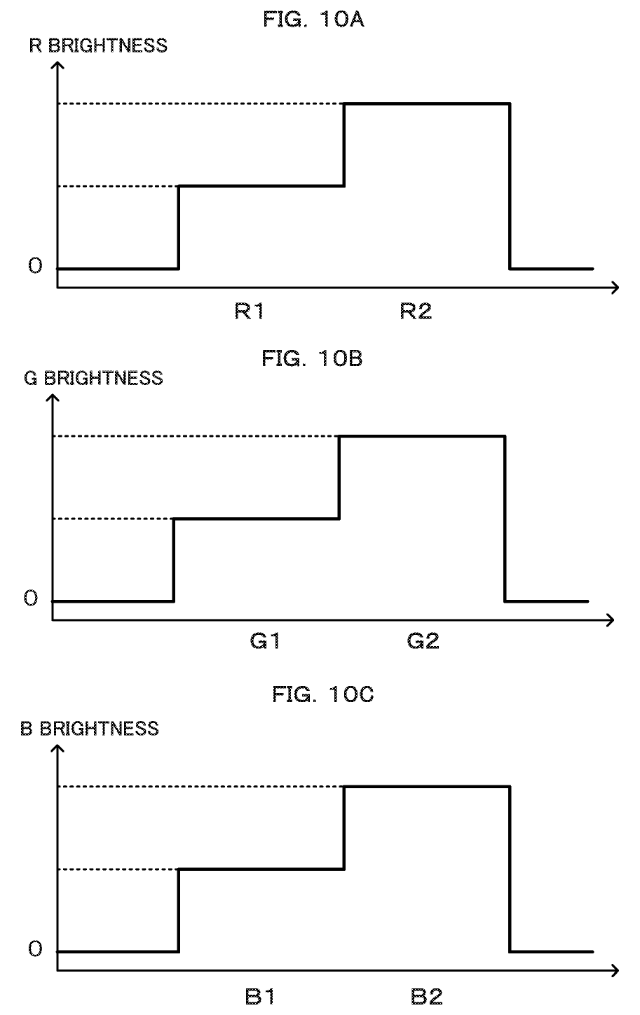

In Embodiment 1 described above, a signal pattern L is detected by detecting the temporal change in the color of the visible light as the temporal change in the state of the visible light, and in Embodiment 2 described above, a signal pattern L is detected by detecting the temporal change in the brightness of the visible light as the temporal change in the state of the visible light. However, the present disclosure is not limited to the embodiments. It may be configured such that a signal pattern L is detected by detecting the temporal change in the brightness and color of the visible light as the temporal change in the state of the visible light. For example, the transmitters 2A and 2B may be configured to adjust the brightness of each of the R light, the G light, and the B light at two levels, as illustrated in FIGS. 10A to 10C, and represent a signal pattern L with a light emission pattern expressible using six brightness levels R1, R2, G1, G2, B1, and B2. For example, a signal pattern L that changes in the order of R1, G1, R1, R2, B1, and so on can be generated. When such a signal pattern L is generated, the number of expressible patterns can be further increased. Note that in this case, information indicating a level of the signal needs to be configured to be included in the event data e, in addition to a light reception position, a time, and a polarity.

The optical communication systems 1A and 1B according to the above-described embodiment can be used for various uses. For example, by incorporating the receiver 3A or 3B and the decoder 5A or 5B into a smart glass, the optical communication system 1A or 1B can be used for communication between the smart glass and an external device. In addition, it may be configured such that the transmitter 2A or 2B and the encoder 4A or 4B are installed on an expressway and the receiver 3A or 3B and the decoder 5A or 5B are installed in a traveling vehicle and transmission and reception of optical signals are performed between the expressway and the traveling vehicle. Transmitting and receiving optical signals in this way enable information such as congestion information to be transmitted to the vehicle.

In addition, although in the above-described embodiments, only one set of the transmitter 2A or 2B and the encoder 4A or 4B is provided, it may be configured such that a plurality of sets of such devices (a plurality of markers) is installed and the same receiver 3A or 3B can receive optical signals from the plurality of sets of devices. Even when optical signals from the transmitters 2A or 2B that are placed at a plurality of different positions are received by the same receiver 3A or 3B, the optical signals can be discriminated by the xy positions included in event data e detected from the optical signals.

Note that in the above-described embodiments, transmission data D are divided into a first numerical value D1 that is a value represented by a plurality of higher-order decimal digits and a second numerical value D2 that is a value represented by the remaining lower-order decimal digits, and the change pattern Pm is generated from the first numerical value D1 and a frequency fn is determined from the second numerical value D2. However, the present disclosure is not limited to the configuration. For example, the frequency fn may be determined from a value represented by the plurality of higher-order decimal digits, and the change pattern Pm may be generated from a value represented by the plurality of lower-order decimal digits. In addition, the first numerical value D1 and the second numerical value D2 may be built up by combining discontinuous digits.

Note that although in the above-described embodiments, encoding and decoding are performed with reference to a table in which a first numerical value D1 and the change pattern Pm are associated with each other and a table in which a second numerical value D2 and a frequency fn are associated with each other, the present disclosure is not limited thereto. The encoding and decoding may be configured to be performed using the change pattern Pm expressed by a binary number that directly represents a first numerical value D1 (the change pattern Pm that is expressed in binary notation and corresponds to the first numerical value D1). In addition, the encoding and decoding may be configured to be performed using a frequency fn directly representing a second numerical value D2 (a frequency fn representing a second numerical value D2). That is, it may be configured such that the change pattern Pm is obtained from a first numerical value D1 and a frequency fn is obtained from a second numerical value D2 not by referring to a table but through calculation.

The optical communication systems 1A and 1B according to the above-described embodiments perform communication using the visible light, and there is no particular restriction on a wavelength of the visible light. In general, light with a wavelength in a range of wavelength that allows light to be considered as the visible light can be used for the communication.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A decoding method that is executed by a processing device to process event data that are event data output from a receiver that receives the visible light emitted from a transmitter and including a position at which a change in brightness has occurred within a light receiving surface of the receiver, a time at which the change in brightness has occurred, and a polarity of the change, the decoding method comprising:
detecting a change pattern that indicates a temporal change in a state of the visible light, based on the event data that are output from the receiver;
detecting a frequency at which the change in the state of the visible light occurs, based on the change pattern; and
decoding transmission data corresponding to the temporal change in the state of the visible light emitted from the transmitter by combining a first numerical value obtained from the change pattern and a second numerical value obtained from the frequency.

2. The decoding method according to claim 1, wherein the decoding method detects the change pattern by detecting a temporal change in brightness of the visible light as the temporal change in the state of the visible light, based on the event data that are output from the receiver.

3. The decoding method according to claim 1, wherein the decoding method detects the change pattern by detecting a temporal change in color of the visible light as the temporal change in the state of the visible light, based on the event data that are output from the receiver.

4. The decoding method according to claim 1, wherein the decoding method detects the change pattern by detecting temporal changes in brightness and color of the visible light as the temporal change in the state of the visible light, based on the event data that are output from the receiver.

5. The decoding method according to claim 3, wherein
the receiver includes:
a color filter in which a plurality of filter elements each of which has a different color component to be transmitted is arranged; and
an image sensor on the light receiving surface of which a plurality of imaging pixels that are arranged in a one-to-one correspondence with the filter elements is provided.

6. An encoding method that is executed by a processing device to encode transmission data into a change pattern that indicates a temporal change in a state of the visible light emitted from a transmitter, the encoding method comprising:
dividing the transmission data into a first numerical value represented by a predetermined plurality of digits and a second numerical value represented by a remaining digit; and
encoding the transmission data into a signal pattern in which the state of the visible light changes at a frequency obtained from the second numerical value in accordance with the change pattern obtained from the first numerical value.

7. A decoding system that decodes, based on event data that are event data output from a receiver that receives the visible light emitted from a transmitter and including a position at which a change in brightness has occurred within a light receiving surface of the receiver, a time at which the change in brightness has occurred, and a polarity of the change, transmission data corresponding to a temporal change in a state of the visible light emitted from the transmitter, the decoding system comprising:
a receiver that receives the visible light and outputs the event data; and
a computer that processes the event data,
wherein the computer includes:
a first detector that detects a change pattern indicating the temporal change in the state of the visible light, based on event data that are output from the receiver;
a second detector that detects a frequency at which the change in the state of the visible light occurs, based on the change pattern; and
a decoder that decodes, based on a first numerical value obtained from the change pattern and a second numerical value obtained from the frequency, transmission data corresponding to the temporal change in the state of the visible light emitted from the transmitter.

8. An encoding system that encodes transmission data into a change pattern that indicates a temporal change in a state of the visible light, the encoding system comprising:
a transmitter that transmits the visible light;
a receiver that receives the visible light and outputs event data; and
a computer that processes the event data,
wherein the computer functions as:
a divider that divides the transmission data into a first numerical value represented by a predetermined plurality of digits and a second numerical value represented by a remaining digit; and
an encoder that encodes the transmission data into a signal pattern in which the state of the visible light changes at a frequency obtained from the second numerical value in accordance with the change pattern obtained from the first numerical value.
